(19) United States
(12) Patent Application Publication
(10) Pub. No.: US 2014/0286817 A1
(43) Pub. Date: Sep. 25, 2014

(54) METHOD OF PREPARING NANOCOMPOSITE MAGNET USING ELECTROLESS OR ELECTRO DEPOSITION METHOD

(71) Applicants: INDUSTRY-UNIVERSITY COOPERATION FOUNDATION HANYANG UNIVERSITY ERICA CAMPUS, Ansan-si, Gyeonggi-do (KR); LG ELECTRONICS INC., Seoul (KR)

(72) Inventors: Jinbae Kim, Gunpo-si (KR); Jongryoul Kim, Ansan-si (KR); Sanggeun Cho, Ansan-si (KR); Namseok Kang, Seongnam-si (KR)

(21) Appl. No.: 14/348,183

(22) PCT Filed: Jan. 9, 2013
(86) PCT No.: PCT/KR2013/000164

§ 371 Date: Mar. 28, 2014

(30) Foreign Application Priority Data
Mar. 30, 2012 (KR) 10-2012-0033498

(51) Int. Cl. H01F 1/03; H01F 41/02; C25D 1/00; H01F 41/00

(52) U.S. Cl. CPC H01F 1/03; H01F 41/005; H01F 41/02; C25D 1/006
USPC 419/38; 427/132; 427/129; 419/65; 205/74

(57) ABSTRACT

The present invention relates to a method of producing a large amount of hard-soft magnetic nanocomposite powder in short time. The hard-soft magnetic nanocomposite powder of present invention has some merits such as independence from resource supply problem of rare earth elements and low price and can overcome physical and magnetic limitations possessed by the conventional ferrite monophased material.

### TECHNICAL FIELD

The present invention relates to a method of preparing a nanocomposite magnet using electroless or electro deposition method.

### BACKGROUND ART

Neodymium magnet is a sintered product comprising neodymium (Nd), iron oxide (Fe), and Boron (B) as main components, which is featured by very excellent magnetic property. Although demand for this high property neodymium bulk magnet has increased, imbalance of demand and supply of the rare-earth elements obstructs supply of high performance motor necessary for next generation industry.

Samarium cobalt magnet which comprises samarium and cobalt as main component is known to have very excellent magnetic property next to the neodymium magnet, but the problem of demand and supply of samarium, one of rare-earth elements, also causes rise of production cost.

Ferrite magnet is a low priced magnet with stable magnetic property which is used when strong magnetic force is not required. Ferrite magnet is produced by powder metallurgy in general, and usually black colored. The chemical form of ferrite magnet is XO+Fe₂O₃, wherein X may be barium or strontium depending on its uses. The ferrite magnet is classified into the dry-processed or wet-processed according to its manufacturing methods, or into the isotropic or anisotropic according to its magnetic direction. The ferrite magnet is a compound consisting of oxides, therefore it is an insulator and has almost no loss of high frequency such as excessive current loss, even if it is operated in a magnetic field of high frequency. The isotropic magnet has lower magnetic force than anisotropic, but has several advantages such as low price and free attachment. The ferrite magnet has been used in diverse applications such as D.C motor, compass, telephone, tachometer, speaker, speed meter, TV, reed switch, and clock movement, and has several advantages such as its light weight and low price. However, the ferrite magnet has also a disadvantage that it does not show an excellent magnetic property enough to substitute high priced neodymium bulk magnet.

In this connection, Japanese Laid-Open Patent Publication No. 2010-74062 describes NdFeB/FeCo nano composite magnet and preparing method thereof as an attempt to improve a magnetic property. However, since the NdFeB/FeCo nanocomposite magnet includes Nd, a rare earth element (REE), in its hard magnetic phase, it is not free from the supply problem of REE and production cost issue. In addition, since it is prepared by a chemical method, it has also an disadvantage that mass production of the nanocomposite magnet powder in short time is impossible.

Until now, no method has been known that can prepare hard-soft magnetic nanocomposite powder without using a chemical method, which is generally known to require a lot of time, and is inadequate for mass production.

This is also confirmed by the above mentioned Japanese Laid-Open Patent Publication No. 2010-74062, which describes that it is impossible to obtain nano-sized hard-soft magnetic nanocomposite magnet powder using a conventional metallurgical technique.

Throughout the present application, several patents and publications are referenced and citations are provided. The disclosure of these patents and publications is incorporated into the present application in order to more fully describe this invention and the state of the art to which this invention pertains.

### DISCLOSURE OF INVENTION

### Technical Problem

Inventors of the present invention have studied and given effort to develop a method to prepare large amount of nano-sized hard-soft magnetic composite powder within short time, and completed the present invention by preparing nano-sized hard-soft magnetic composite powder using electroless or electrodeposition method successfully.

Accordingly, an object of the present invention is to provide a method to prepare hard-soft magnetic nanocomposite powder using electroless deposition method.

Another object of the present invention is to provide a method to prepare hard-soft magnetic nanocomposite powder using electrodeposition method.

Another object of the present invention is to a method to prepare a bonded magnet or a sintered magnet using the above hard-soft magnetic nanocomposite powder prepared by using electroless or electrodeposition method.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### Solution to Problem

Until now, hard-soft nanocomposite magnet has been prepared by chemical methods known that much time is required and mass production is difficult and it has been known that obtaining nano-sized hard-soft magnetic nanocomposite magnet powder with the conventional metallurgical techniques is impossible. Inventors of the present invention have studied and given effort to develop a method to prepare large amount of nano-sized hard-soft magnetic composite powder within short time, and completed the present invention by coating soft magnetic matter on the surface of ferrite nanopowder, molded or sintered matter and preparing nano-sized hard-soft magnetic composite powder using electroless or electrodeposition method successfully.

An objective of the present invention is to provide a method to prepare nanocomposite powder having hard-soft magnetic heterostructure using electroless deposition method including following steps comprising: (i) a step to activate the surface of ferrite nanoparticle, a hard magnetic matter; and (ii) a step to coat the surface activated nanoparticle by submerging it into a gilding solution including at least one metal ion selected from the group comprising nickel, iron, cobalt, aluminum, gold, platinum, silver, copper, palladium, tin, zinc, and chromium. The electroless deposition method is a process that has a merit that the production cost is lowered due to simpler process than general powder coating methods and is proper to mass production because rapid production is possible.

(i) Step to Activate the Surface of Ferrite Nanoparticle, a Hard Magnetic Material

The electroless deposition needs an activation layer which plays a role in creating a core to allow reduction of the soft magnetic metal material to be coated on the surface of hard magnetic material in ionic state within the gilding solution. The above process is referred as surface activation process, which may be progressed with 2 steps generally.

Step \textcircled{1} is a process to raise surface reactivity of the hard magnetic powder for forming the activation layer, which is called as sensitization process. This process is a process to make Sn²⁺ ion deposited onto the surface of hard magnetic powder using Sn²⁺ and for instance may be performed by submerging the hard magnetic powder into a mixture containing SnCl₂ and an acid in ultrapure water at room temperature.

The above hard magnetic powder may include ferrite nanoparticle and preferably, include at least one nanoparticle selected from the group comprising barium ferrite nanoparticle, strontium ferrite nanoparticle and cobalt ferrite nanoparticle.

Step \textcircled{2} is activation process to form the activation layer. The activation layer may be formed by using Pd and plays a role as a core creation site to allow reduction of metal ions on the surface of ceramic powder. Concretely, the activation process may be performed by submerging the sensitized hard magnetic powder into a mixture containing PdCl₂ and HCl in ultrapure water at room temperature.

Like these, although the process to activate surface of ferrite nanoparticle, a hard magnetic material, may be performed by 2 step process including sensitization process to make tin ions deposited to the surface of ferrite nanoparticle and activation process to form a palladium activation layer on the ferrite nanoparticle, it may be also performed by 1 step sensitization and activation process to form the palladium activation layer on the surface of ferrite nanoparticle by submerging it into the solution containing tin ions and palladium ions. In this case, there is a merit to shorten more time required for preparing nanocomposite powder having hard-soft magnetic het- erostructure.

(ii) Step to Coat the Surface of Activated Nanoparticle

This process is to form a hard-soft magnetic nanocomposite structure after the above surface activation process, which will go through electroless deposition process. This process is to form a hard-soft magnetic nanocomposite structure by reducing metal ion to metal after inducing the hard magnetic powder to be a core creation cite of metal ion in the activation layer by submerging it into a gilding solution containing the soft magnetic metal to be deposited, wherein the gilding solution may includes at least one metal ion selected from the group comprising nickel, iron, cobalt, aluminum, gold, platinum, silver, copper, palladium, tin, zinc and chromium.

For example, in order to perform electroless gilding of Ni, a solution containing Ni-sulfate(deposition material), sodium hypophosfate (reducing agent), sodium pyrophosphate(deposition rate controller), and ammonia solution(pH control) in ultrapure water (solvent).

Another objective of the present invention is to provide a method to prepare nanocomposite powder having hard-soft magnetic heterostructure using electro deposition method including following steps comprising: (i) a step to locate the ferrite nanoparticle, a hard magnetic matter, on the board; and (ii) a step to load current to the board in electrolyte solution including at least one metal ion selected from the group comprising nickel, iron, cobalt, aluminum, gold, platinum, silver, copper, palladium, tin, zinc, and chromium.

The electro deposition is progressed by using a method same to general deposition in order to form a soft magnetic metal coating layer on hard magnetic powder. Concretely, fix the hard magnetic powder on the board where the deposition is done and induce formation of soft magnetic coating layer. Because the hard magnetic ceramic powder is generally non-conductive, it is important to locate them evenly on the conductive board.

The above ferrite nanoparticle may include at least one nanoparticle selected from the group comprising barium ferrite nanoparticle, strontium ferrite nanoparticle and cobalt ferrite nanoparticle.

In an embodiment, the above electro deposition forms a coating layer by adusting current density, temperature, and time with 3-electrode system after locating hard magnetic powder or powder type molded matter on the conductive board.

For example, when gilding NiFe, the deposition is progressed after adjusting current density, temperature, and time to obtain desired composition, using a gilding solution prepared by mixing FeCl₂, NiCl₂, CaCl₂, and L Ascorbic acid in ultrapure water.

The above coating method makes the fine soft magnetic nanoparticle coated evenly on the relatively lager hard magnetic nanoparticle. When using the method of present invention, it is possible to control the thickness of coating layer by adjusting time and temperature in deposition, so there is an effect able to control coercive force and magnetization value of the nanocomposite.

When the prepared soft magnetic coating layer prepared by performing the above electroless or electro deposition is an oxide, it is possible to prepare nanocomposite by reducing it to pure metal through thermal reduction formed from the provision of reduction atmospheric gas. For instance, the reduction atmospheric gas may include 99% of hydrogen, 5% of hydrogen, and 95% of nitrogen or hydrazine atmosphere, and preferably be 99% of hydrogen atmosphere.

In a preferred embodiment of the present invention, the hard-soft magnetic nanocomposite powder prepared with electroless or electro deposition method may improve sintering density and magnetic property further when sintering it using selectively thermal treatment at high temperature or thermal treatment at low temperature using pulsed current sintering.

The soft-hard magnetic nanocomposite powder prepared by the method of present invention materializes both high coercive force and high saturation flux density, so it can be applied to materials for high performance permanent magnet. Therefore the nanocomposite magnet prepared by using this is found to have highly improved coercive value and saturation magnetization value in comparison with those of conventional ferrite magnet.

In an embodiment, the hard-soft nanocomposite powder prepared by the method of present invention shows nano-scaled size as 10 to 1000 nm and preferably has 50 to 300 nm of diameter.

In another embodiment, the nanocomposite prepared by the method of present invention may use at least one matter selected from the group comprising strontium ferrite, cobalt ferrite, and barium ferrite having M type or W type of crystal structure as nanopowder, molded matter, or sintered matter, which may be prepared by forming a soft magnetic coating layer corresponding to at least one selected from the group comprising Fe, Co, Ni, FeCo, FeNi, FeSi and CoNi on the hard magnetic material.

In another embodiment, the content of soft magnetic coating layer in the above nanocomposite is more than 1 wt % and less than 80 wt %.

Another object of the present invention is to provide a method to prepare a bonded magnet including following steps comprising: (i) a step to disperse the hard-soft magnetic nanocomposite powder prepared by the above electroless or electro deposition method; (ii) a step to prepare a compound by mixing thermosetting or thermoplastic plastics and the above powder; and (iii) a step to prepare an extrusion or injection molded bonded magnet by extrusion molding of the above mixture.

Another object of the present invention is to provide a method to prepare a sintered magnet including following steps comprising: (i) a step to perform magnetic filed molding to the hard-soft magnetic nanocomposite powder prepared by the above electroless or electro deposition method; and (ii) a step to sinter the above molded body.

The above magnetic field molding may be performed by loading external magnetic field in direction selected between horizontal and vertical axis the above sintering may be performed by at least one selected from the group comprising furnace sintering, spark plasma sintering, and microwave sintering and hot press.

### Advantageous Effects of Invention

The method of present invention using electroless or electro deposition has a merit capable of mass production of hard-soft magnetic nanocomposite powder in short time.

The prepared hard-soft magnetic nanocomposite powder of present invention has some merits such as independence from resource supply problem of rare earth elements and low price and can overcome physical and magnetic limitations possessed by the conventional ferrite mono-phased material.

### BRIEF DESCRIPTION OF DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a TEM (Transmission Electron Microscope) image of the nanocomposite powder having hard-soft magnetic heterostructure prepared according to the present invention.

FIG. 1 shows results of film composition analysis deposited in atom scale size on the nanocomposite powder having hard-soft magnetic heterostructure prepared according to the present invention using EDS.

FIG. 3 is a graph obtained by magnetic measurement of the nanocomposite powder having hard-soft magnetic heterostructure prepared according to the present invention.

### BEST MODE FOR CARRYING OUT THE INVENTION

The present invention will now be described in further detail by examples. It would be obvious to those skilled in the art that these examples are intended to be more concretely illustrative and the scope of the present invention as set forth in the appended claims is not limited to or by the examples.

### EXAMPLE

Preparation of Hard-Soft Nanocomposite Powder using Electroless Deposition

Surface Sensitization and Activation Process

\textcircled{1} Sensitization process: To ultrapure water, SnCl₂(10 g/l) and HCl(37%, 40 mΛ/l) were added and stirred. Then, 100 mg/l barium ferrite nanopowder (SIGMA-ALDRICH) was submerged into the solution and left at room temperature for about 3 min so that Sn²⁺ ions are absorbed onto the surface of barium ferrite.

\textcircled{2} Activation process: The resultant sensitized barium ferrite powder was submerged into a solution prepared by dissolving PdCl₂ (1.0 g/l) and HCl (37%, 10 mΛ/l) in ultrapure water, and left at room temperature for about 2 min.

Deposition Process

Gilding solution (pH 10) was prepared by dissolving Ni-sulfate (NiSO₄·H₂O, 25 g), Sodium hypophosphate (NaH₂PO₂·H₂O, 25 g), Sodium pyrophosphate (Na₄P₂O₇, 50 g) and Ammonia solution(NH₄OH, 23 mΛ) in 1000 mL of ultrapure water.

The barium ferrite powder obtained from the above surface activation process was submerged into the gilding solution and left at 35° C. for 10 min to induce core formation of nickel ion on the activated surface layer, and then reduce the nickel ion into nickel metal.

Then, the powder was filtered out and dried at room temperature to obtain hard-soft magnetic nanocomposite powder where nickel is deposited on the surface of barium ferrite.

Preparation of Hard-Soft Nanocomposite Powder Using Electro Deposition

Gilding solution was prepared by dissolving FeCl₂ (0.9 M), NiCl₂ (0.6 M) and CaCl₂ (1.0 M), L' Ascorbic acid (0.03 M) in ultrapure water.

Barium ferrite nanopowder (SIGMA-ALDRICH) was evenly located onto a working electrode where deposition is to take place, and then nickel coating layer was formed on the surface of the barium ferrite nanopowder by loading electric current (striking 50 mA/cm² and deposition 5 mA/cm²) at 40° C. for 1 hr, using a 3-electrode system, where a platinum coated titanium electrode was used as a counter electrode and a Ag/AgCl electrode in saturated calcium chloride solution was used as a reference electrode.

EDS (Energy Dispersive Spectrometer) Analysis Using TEM (Transmission Electron Microscopy)

Using TEM (Jeol, JEM2010), shape and size of the hard-soft magnetic nanocomposite powder were measured. Concretely, after putting the prepared barium ferrite-nickel nanocomposite powder into ethanol and dispersing it using an ultra-sonicator, small amount of the solution was dropped on a copper grid. Then, after drying it in the air to prepare a sample to be observed with TEM, its shape and size were measured using TEM and film composition analysis was performed with EDS.

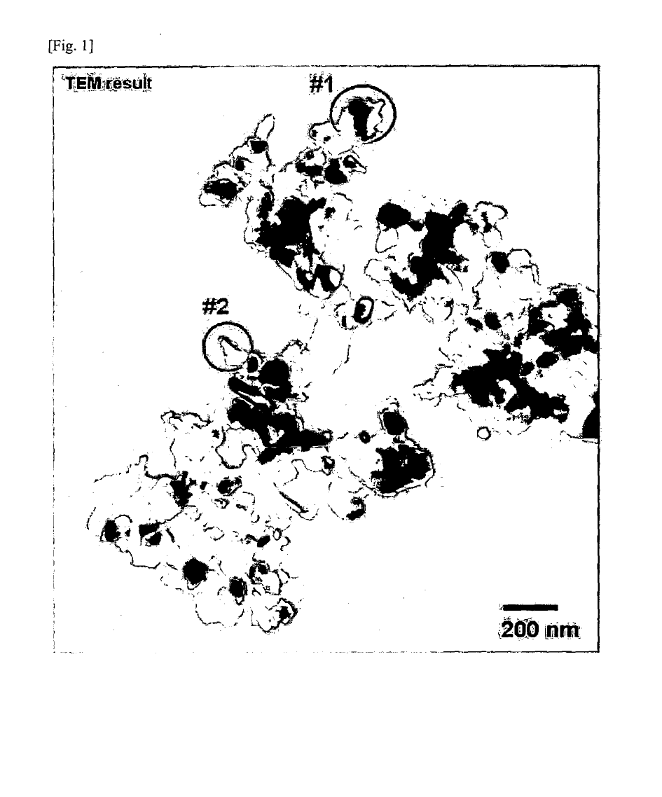

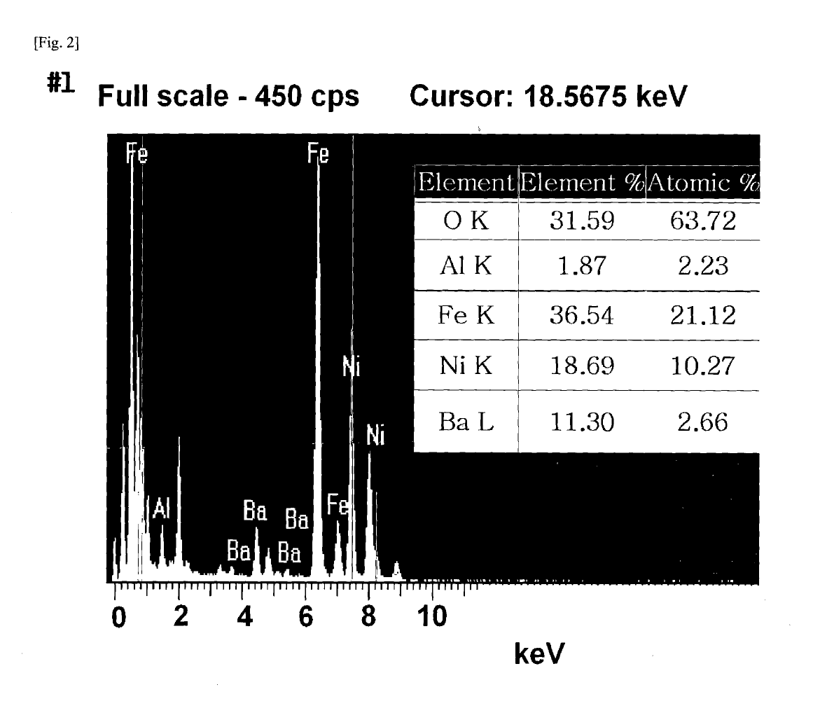

FIG. 1 is a TEM image showing the analysis results and FIG. 2 shows results of film composition analysis deposited in atom scale size with EDS. As shown in FIG. 1 and FIG. 2, it was found that the nickel was deposited evenly on the barium ferrite and its diameter was 50 to 300 nm.

Measurement of Magnetism

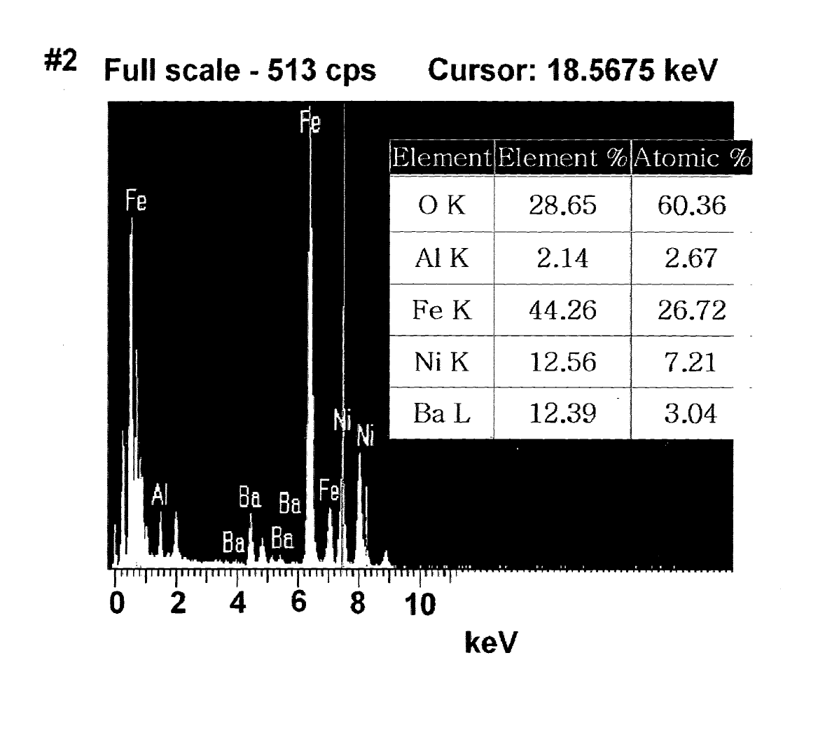

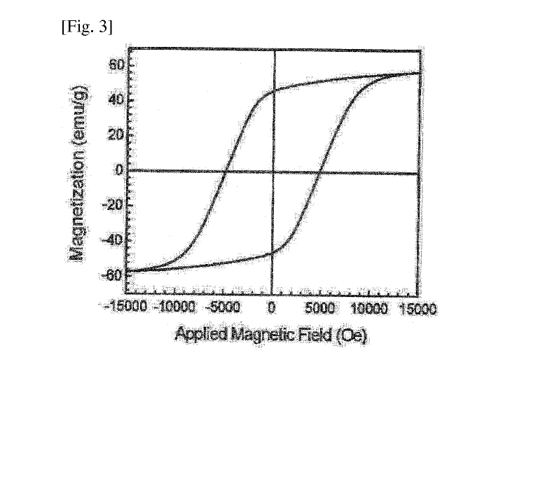

Magnetism of the prepared barium ferrite-nickel nanocomposite powder was measured using VSM (vibration sample magnetometer, Toei, VSM-5) and its results were provided in FIG. 3.

As shown in FIG. 3, coercive force and saturation magnetization value of the prepared barium ferrite-nickel nanocomposite powder were 4858 Oe and 58 emu/g respectively, and it was confirmed that the nanopowder has both of the high coercive force of the hard magnetic phase and the high saturation flux density of the soft magnetic phase.

Preparation of Magnet

The present invention also provides a method of preparing of a magnet using the hard-soft magnetic nanocomposite powder.

(1) Preparation of Bonded Magnet

Concretely, a bonded magnet is prepared by a method comprising the following steps: (i) preparing powder by dispersing the hard-soft magnetic nanocomposite powder; (ii) preparing a mixture by mixing thermosetting or thermoplastic synthetic resin and the above powder; and (iii) forming a bonded magnet by extruding or injecting the above mixture.

(2) Preparation of Sintered Magnet

A sintered magnet is prepared by a method comprising the following steps: (i) performing a magnetic field molding of the hard-soft magnetic nanocomposite powder prepared according to the above preparing method; and (ii) sintering the above molded body. Alternatively, one step process unifying the magnetic field molding and sintering corresponding to the above (i) and (ii) step may be applied. When carrying out the magnetic field molding, the loading direction of external magnetic field may be horizontal or vertical.For sintering process, at least one technique may be selected and applied from furnace sintering, spark plasma sintering, and microwave sintering and hot press.

1. A method of preparing nanocomposite powder having hard-soft magnetic heterostructure using electroless deposition method, comprising the following steps:
(i) activating surface of ferrite nanoparticle which is hard magnetic; and
(ii) coating the activated surface of the ferrite nanoparticle with soft magnetic substance by submerging the activated ferrite nanoparticle into a gilding solution containing at least one metal ion selected from nickel, iron, cobalt, aluminum, gold, platinum, silver, copper, palladium, tin, zinc, and chromium ion.

2. The method according to claim 1, wherein the step (i) is carried out by 2-step process of
sensitization process to deposit tin ions onto the surface of the ferrite nanoparticle; and
activation process to form a palladium activation layer on the surface of the ferrite nanoparticle.

3. The method according to claim 1, wherein the above step (i) is carried out by 1-step sensitization and activation process to form a palladium activation layer on the surface of the ferrite nanoparticle by submerging the ferrite nanoparticle into a solution containing tin ions and palladium ions.

4. A method of preparing nanocomposite powder having hard-soft magnetic heterostructure using electro deposition method, comprising the following steps:
(i) locating ferrite nanoparticle which is hard magnetic on a working electrode; and
(ii) loading electric current on the working electrode in an electrolyte solution containing at least one metal ion selected from nickel, iron, cobalt, aluminum, gold, platinum, silver, copper, palladium, tin, zinc, and chromium ion.

5. The method according to claim 1, wherein the hard-soft magnetic nanocomposite powder has 10 to 1000 nm of diameter.

6. The method according to claim 1 [[or 4]], wherein the hard-soft magnetic nanocomposite powder has 50 to 300 nm of diameter.

7. The method according to claim 1, wherein the ferrite nanoparticle comprises at least one nanoparticle selected from barium ferrite nanoparticle, strontium ferrite nanoparticle, and cobalt ferrite nanoparticle.

8. The method according to claim 1, wherein the method further comprises carrying out thermal reduction treatment to the obtained hard-soft magnetic nanocomposite powder.

9. A method of preparing a bonded magnet comprising the following steps:
(i) dispersing the hard-soft magnetic nanocomposite powder prepared by the method according to claim 1;
(ii) preparing a mixture by mixing the powder with a thermosetting or thermoplastic synthetic resin; and
(iii) forming a bonded magnet by extruding or injecting the mixture.

10. A method of preparing a sintered magnet comprising the following steps:
(i) performing magnetic field molding of the hard-soft magnetic nanocomposite powder prepared according to claim 1; and
(ii) sintering the molded body.

11. The method according to claim 10, wherein the magnetic field molding is performed by loading external magnetic field in direction of horizontal or vertical axis.

12. The method according to claim 10, wherein the sintering is performed by at least one selected from furnace sintering, spark plasma sintering, and microwave sintering, and hot press.

13. The method according to claim 4, wherein the hard-soft magnetic nanocomposite powder has 10 to 1000 nm of diameter.

14. The method according to claim 4, wherein the hard-soft magnetic nanocomposite powder has 50 to 300 nm of diameter.

15. The method according to claim 4, wherein the ferrite nanoparticle comprises at least one nanoparticle selected from barium ferrite nanoparticle, strontium ferrite nanoparticle, and cobalt ferrite nanoparticle.

16. The method according to claim 4, wherein the method further comprises carrying out thermal reduction treatment to the obtained hard-soft magnetic nanocomposite powder.

17. A method of preparing a bonded magnet comprising the following steps:
(i) dispersing the hard-soft magnetic nanocomposite powder prepared by the method according to claim 4;
(ii) preparing a mixture by mixing the powder with a thermosetting or thermoplastic synthetic resin; and
(iii) forming a bonded magnet by extruding or injecting the mixture.

18. A method of preparing a sintered magnet comprising the following steps:
(i) performing magnetic field molding of the hard-soft magnetic nanocomposite powder prepared according to claim 4; and
(ii) sintering the molded body.
